(19) United States
(12) Patent Application Publication
(10) Pub. No.: US 2014/0122479 A1
(43) Pub. Date: May 1, 2014

(54) Automated file name generation

(71) Applicant: ABBYY SOFTWARE LTD., Nicosia (CY)

(72) Inventors: Vasily Panferov, Moscow (RU); Andrey Isaev, Dolgoprudny (RU)

(73) Assignee: ABBYY Software Ltd., Nicosia (CY)

(21) Appl. No.: 13/712,962

(22) Filed: Dec. 12, 2012

Related U.S. Application Data
(63) Continuation-in-part of application No. 13/662,044, filed on Oct. 26, 2012.

(51) Int. Cl. G06F 3/06

(52) U.S. Cl. CPC G06F 3/0643
USPC 707/736

(57) ABSTRACT

Described herein are methods for determining a type and semi-unique features of electronic files. The methods generally include generating at least one document hypothesis corresponding to the type of the document. For each document hypothesis, the document type is verified. A document type hypothesis is selected. A document name is formed based on the selected document type hypothesis and one or more features of the document. Such steps generally include automatically or programmatically naming of electronic files. A unique or semi-unique name is given, one that reproduces some of the document's contents, attributes and/or characteristics. Each document is provided with a name that can be easily understood and that is related to the content of the document.

### CROSS-REFERENCE TO RELATED APPLICATIONS

For purposes of the USPTO extra-statutory requirements, the present application constitutes a continuation-in-part of U.S. patent application Ser. No. 13/662,044 filed on 26 Oct. 2012 initially titled “Automated File Name Generation,” which is a continuation-in-part of U.S. patent application Ser. No. 12/749,525 filed on 30 Mar. 2010 initially titled “Automatic File Name Generation In OCR Systems,” which (in turn) is a continuation-in-part of U.S. patent application Ser. No. 12/236,054 titled “Model-Based Method of Document Logical Structure Recognition in OCR Systems” that was filed on 23 Sep. 2008, which is currently co-pending, or is an application of which a currently co-pending application is entitled to the benefit of the filing date. Patent application Ser. No. 12/236,054 claims the benefit of priority to U.S. 60/976,348 which was filed on 28 Sep. 2007.

The United States Patent Office (USPTO) has published a notice effectively stating that the USPTO's computer programs require that patent applicants reference both a serial number and indicate whether an application is a continuation or continuation-in-part. See Stephen G. Kunin, Benefit of Prior-Filed Application, USPTO Official Gazette 18 Mar. 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND OF THE INVENTION

1. Field

Embodiments of the present invention are directed towards implementations and functionalities related to an electronic file storage and management system operable on a variety of devices and across many storage mediums. At least some embodiments are directed towards optical character recognition (OCR) and intelligent character recognition OCR (ICR) that is capable of processing documents.

2. Description of the Related Art

Computer users generate a great amount of electronic files that are stored on personal computers, mobile devices, portable storage devices, and cloud services. As the volume of files expands the ability to find and sort the files efficiently becomes more important and difficult. One option for locating files is to give each file a text-based name that briefly describes the form and substance of the document contained within the file. Usually, users must create names manually when saving or sending documents and often fail to do so for all but the most important documents. At best, currently available applications provide a name for a document based on text found as a first line of a yet-to-be-named document or with information or default text available to the application naming the document.

One option for locating documents is to give each document a text-based name that briefly describes its form and substance. Currently, users must create file names manually when saving or sending documents, often failing to do so except for the most important documents. Often, users save documents into a single store, and over time accumulate documents with names such as, “image_{—}0001.jpg”, and “21082008.pdf”, making recollection of their contents and searches for particular or important documents almost impossible. For example, when processing groups or batches of documents with an OCR application, the output is typically a batch or group of documents with recognized data with files named according to a generic pattern, for example: “Document0001,” “Document0002,” etc. The resulting documents may be sent to the user by e-mail or placed in a pre-defined folder.

When a user regularly accumulates a large number of unnamed documents, the result is a multitude of files with similar-looking meaningless names in the user's mailbox or pre-defined folder. Opening and checking the contents of these files and renaming them involve a significant amount of repetitive manual work and substantial loss of time. Therefore, there is substantial opportunity to automate this process and provide meaningful names to such files.

### SUMMARY

The invention provides methods for determining one or more document types associated with a document or electronic file and its unique features. The method comprises generating at least one document hypothesis for corresponding to the type of the document. For each document hypothesis, the method further comprises verifying said document type hypothesis, selecting a document type hypothesis, and forming a document name based on the best type hypothesis and one or more unique features of the document. This method can be repeated for a batch of electronic files.

Further, this application describes methods of automatically naming documents or electronic files. Each electronic file processed through this system receives a unique or semi-unique name that describes some of the electronic file's contents, attributes and/or characteristics. One exemplary output of the described technology is one or more possible names for each of the user's electronic files which allow one to understand the contents and significance of each electronic file.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings.

FIG. 1 shows examples of sources of data for tags.

FIG. 2 shows an example of a particular type of document (recipe) from which to extract data for tags.

FIG. 3 shows an example of another particular type of document (business card) from which to extract data for tags.

FIG. 4A shows a flowchart in accordance with one embodiment of the invention.

FIG. 4B shows a flowchart for a detailed algorithm of a method in accordance with one embodiment of the invention.

FIG. 4C shows a flowchart for a method in accordance with another embodiment of the invention.

FIG. 4D shows a flowchart for a method in accordance with another embodiment of the invention.

FIG. 5 shows a data structure and set of data derived from a representation of a document or image in accordance with one embodiment of the invention.

FIG. 6 shows a data structure derived from a representation of a file (document or image) in accordance with another embodiment of the invention.

FIG. 7 shows a variety of document types that may be derived from data associated or derived from a representation of a document in accordance with an embodiment of the invention.

FIG. 8 shows a block diagram of a hardware device for performing methods, in accordance with embodiments of the invention.

### DETAILED DESCRIPTION

The present invention automates the process of file name generation by intelligently naming documents or electronic files based on their form and content making electronic files easier to sort and find. The terms “document” and “electronic file” are used interchangeably herein. Examples of electronic files that could be named automatically include document images in the form of portable document format files (PDF's), scanned forms, email messages, attachments, websites, photos, and others.

One particular class of electronic files is document images originating from scanners, mobile phone photographs, cameras, and email messages, either as attachments or as embedded images. Generally, these images are stored as electronic files for future access and accumulate greatly over time on personal computer and cloud storage locations like in email accounts. As document images accumulate without proper file naming they become particularly difficult to locate.

One option for locating a document image or electronic file is to perform a key word search on the text portions of documents. This requires applying an OCR system that is capable of transforming document images into a computer-readable, computer-editable, and searchable form. OCR systems may also be used to extract data from document images. Typically, OCR systems output a plain text file, with simplified layout and formatting. These files retain simplified properties of the source document such as paragraphs, fonts, font styles, font sizes, and some other simple features. Often these OCR files are not as useful to the user as the original document image. For example, when applying OCR to newspaper or magazine pages with several articles on a page, it may be difficult or impossible to separate one story from another, resulting in an unacceptable text file. Therefore, to facilitate searches for the original document image, OCR systems may enable keyword searches of the previously recognized text in the source document image. The system enables a keyword search by recognizing and indexing the text of each new document image.

The contents of electronic files and images can serve as input information to generate an automatic name for the electronic file. The term “electronic file” herein shall include any collection of electronic data that is capable of having of having at least one tag extracted from it and that may be saved in electronic form. The text of a document or a scanned or photographed image of a document contained within a file may be used. A document image can be one or more pages. An image that includes “vector” or “vector-based” information about the disposition and content of text and graphic elements can also be used as input information. For example, a document image could include a portable document format (PDF) file with a text layer, a vector-based PDF file, an XPS-type file, a DOCX-type file, an XSLX-type file, a plain text (TXT) file, etc. An electronic text document could include text files, emails, websites, social media posts, and annotations.

For example, a document like a newspaper or magazine page may include several different articles with separate titles, inserts, and pictures. In accordance with embodiments of the present invention, a result of performing optical character recognition (OCR) or intelligent character recognition (ICR) is an editable text-encoded document that replicates the logical structure, layout, and formatting of the original paper document or document image that was fed to the system.

A text string briefly reflecting the content of a document can be used as the file name of the document. Such a useful file name is a result of the methods described herein. “File name string” is the term used for this string herein. Certain structural elements of a document or electronic file, their order and spatial relationships, and certain keywords or unique features in titles or in other parts of the electronic file may sometimes be used to compose a file name string. For example, the file name string can include information about a type or category describing the document (e.g., letter, business card). The file name string also can include information from “tags” inside the document (e.g., date, address, names).

“Tags” is the term used herein to describe keywords and unique features of a document as described more fully below. Tags are small parts of a text reflecting a document's properties. For example, the title of the document, the name of the document's author, the date of writing, and the header can be used as a tag.

Each tag may comprise a type (for example: Author) and value (for example: “Mark Twain”). Several examples of types are illustrative: a header, a running title, a page number, a quotation, a date of purchase (such as from a bank statement, receipt), a date that a contract was executed, a url, and an e-mail address.

The tags result from an analysis of a document. At its simplest, the tag can be found in the text (e.g., text string, body of text) of a document. In more sophisticated cases, one or more tags for a document can be calculated or generated on the basis of data contained in the document—hidden data, metadata, format data and data in the content of the document. Also, a tag can be generated from data received or queried from additional sources of knowledge outside of the document. For example, one can find the name of a book's author by performing an internet search. In another case, the name of a book can be recognized from a barcode in an image or a photo of the book's cover.

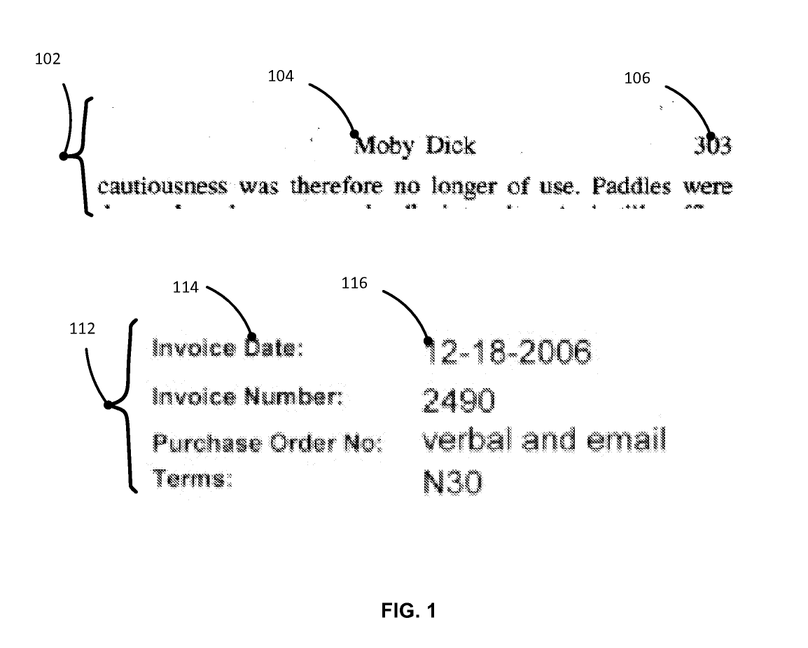

FIG. 1 shows examples of sources of data for tags. With reference to FIG. 1, a top of a page of a book 102 is shown. A title 104 and a page number 106 appear on the top of each page of the corpus of the book. The title 104 and/or the page number 106 can serve as a tag or portion of a tag. A running title may serve as a tag itself and be used as the document name. Also additional data, for example date, page number, book name, author's name and the like, can be found inside the running title, and such information may be used as a tag or portion thereof. One or more tags, or portions thereof, may be combined and used to generate the name of a document.

Also shown in FIG. 1 is a portion 112 of an invoice. One or more keywords or labels 114 can serve as a tag or portion of a tag (e.g., Invoice Date, Invoice Number). The actual keyword data 116 (e.g., “11-12-2006” for invoice date and “2490” for invoice number) can serve as a tag or portion of a tag. For the portion 112 of the invoice, a tag could be “invoice number 2490”.

Features of the document, text-based and non-text-based, can serve as tags or portions of tags—or may be used to identify elements that can serve as tags. For example, font size and relative text location may be used. Running titles, such as the one shown in FIG. 1, are usually located separate from the main document text on each page. Headings are usually located in a centered location and are in a different font than other text on a page. Dates are another example. Dates sometimes have a special formatting and include a day and year. Date-connected tags can be found using these and other relevant features. Telephone numbers include some specific features, too. For example, “(509) 624-0226” includes a set of parentheses with three numbers inside, and a dash between groups of numbers. In another example, “+44 (0) 114 249 9888” includes a set of parentheses, a plus sign, and strategically located spaces between a particular number of numbers (e.g., spaces between groups of 2, 3 or 4 digits).

Sources external to the text or text elements may be used to generate or locate text or data that may be used as the source of a tag or portion thereof. For example, a QR barcode with an encoded URL may be found in an image of a document. A tag generation algorithm may include recognizing this QR barcode, decoding the associated URL, accessing a Web page at the URL, and retrieving information from a header of the accessed Web page.

In yet another embodiment, a telephone number may be found in the document. A tag or portion thereof may be generated by using an external phone book or database of telephone numbers, searching for and locating the number, and retrieving a name of a company associated with the telephone number. In another embodiment, a telephone number may be called and a recording made subsequent to the call reaching a destination (e.g., an automated greeting message of a company); subsequently, a voice to text procedure may be performed, and the text derived from or based on such text may be used as a tag or portion thereof.

In yet another example, when a quotation appears in an image of a document, the quotation may be used to derive the name, birthdate, etc. of its author to be used as a tag or portion thereof.

In another example, if a postal ZIP code appears in an a document, the ZIP code may be used to derive an associated city, state or other information that may then be used as a tag or portion thereof. For a ZIP code in the United States of America, a ZIP code of 10118 could be used to derive “Empire State Building” in New York City.

In another example, suppose a URL and other text appears at the top of a page in a document (such as when creating a PDF document from a Web browser). In this example, suppose that “http://www.ibsen.net/?id=1430” and “30.09.2008” appear along the top of one or more pages of a document. A tag extracting function or functionality may identify the date (i.e., 30.09.2008) and domain name (i.e., ibsen.net). These two tags could be processed together or independently to form the name of the document, e.g., “ibsen_net_{—}1430_{—}2008-09-30.”

A file name string can also be generated at the time of document conversion (e.g., renaming; subjected to OCR, saved and renamed). Such generation may be embedded in or may operate in conjunction with functions of the operating system or file browser (e.g., file explorer). For example, suppose a file has the name “picture_{—}001.jpg”; this file can be saved as “Letter_from_John_{—}30.Aug.12.pdf⇄ when processing is completed. A file browser may facilitate or offer a function titled or named “intelligent renaming.” A user may, for example, right-click on a file, trigger “intelligent renaming,” and without further input or action from a user, may rename the file based upon tags derived from the document according to one or more of the functions and examples described herein. For example, an “intelligent renaming” function may use information obtained or derived the EXIF data from a JPG image file to rename the file from, for example, “img0701.jpg” to “2012_{—}04_{—}28_{—}2041_{—}2240_x_{—}1680”, which includes information about the date and time on which the image was taken, and a width and height (dimensions) of the image. Such renaming could be automated such that a batch of documents (irrespective of file type) may be renamed. For example, a batch of documents that include rich text format (RTF) documents, JPG images and TIFF images may be processes as a batch. Such renaming allows for more useful names of files with a minimal amount of effort required by a user.

In another embodiment, the file naming process could be open to tuning by the user so that the file name reflected the most relevant information to the user. This is accomplished by user input on tag section and file name formatting. For example, the user can adjust the settings such that the author name to always appear in the file name or alternatively such that the company name appears in the file name.

In other embodiment, the file naming process could be implemented on a hard disc drive (HDD or SDD) with software. Such a drive could be a part of RAID system. The process would operate when a user saves electronic documents onto the drive. The system could perform smart naming automatically or perform it if it is approved by user. Such a function could be turned off via a hardware option (such as an additional switch on the drive) or with a software setting. Further, the function could be activated or deactivated with the Master\Slave pins on the HDD or SDD.

Another exemplary function that could be implemented is to use the generated file name and the tags to send files into folders designated to receive certain file types. For instance, folders could be designated as letters, photos, checks, invoices, etc. Additionally the functionality could run on a server and send uploaded files to designated shared folders. Such functionality could operate automatically or upon a prompt to the user.

Another exemplary function that could be implemented using the derived or generated tags is adjusting file properties. File properties can be updated based upon tags derived from the document contained in the file according to one or more of the functions and examples described herein. For example, one or more of the following properties may be specified with data: title, subject, categories, and author name. Such file property categories are dependent upon the file system used (e.g., Linux, Microsoft® Windows®).

In another embodiment, the file naming could be implemented as part of a web browser or search engine. For instance when a user finds a page or file she would like to save or bookmark, the naming function would operate when saving the file or bookmark to give it a meaningful name. This function does not replace traditional the traditional ‘Save as’, but can be an alternative to it. Alternatively, the process could be implemented as part of an electronic messaging system, such as email, whereby a smart name is generated for the subject line of an email when the subject is left blank by the user. This feature could operate automatically or as a user selected option.

In another embodiment, the file naming system could be integrated into a cloud based service like Google Docs, Facebook, or Dropbox, and provide an option for file naming. The file naming feature could operate on all new files uploaded to the service or on files already service. The file names and tag information could subsequently be used to send the files to specific folders in the cloud service.

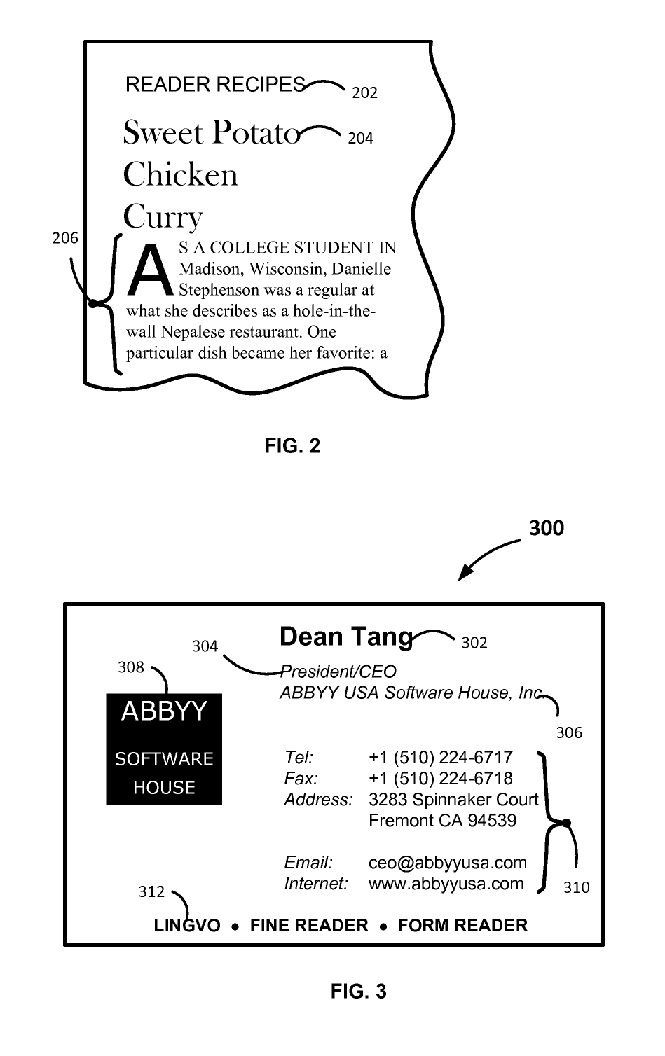

FIG. 2 shows an example of a particular type of document (recipe) from which to extract data for tags. With reference to FIG. 2, a header 202 is present that indicates a title of a section of a newspaper or magazine. In this instance, the header 202 indicates that this document is a recipe. A title 204 indicates the subject or type of recipe. Perhaps later in the body 206 of the recipe ingredients and instructions will be given. From the header 202, title 204 and/or body 206, tags can be generated, and a file name generated. For example, a file name for the image shown in FIG. 2 could be “READER_RECIPE Sweet Potato Chicken Curry.tif” Other information (e.g., date, number of pages, one or more ingredients in the recipe) may be included in the name of the file depending on, for example a preconfigured setting or preference(s) set by a user.

FIG. 3 shows an example of another particular type of document (business card 300) from which to extract data for tags. With reference to FIG. 3, a business card includes, for example, a name 302, a title or roll 304, a company name 306, a logo or “bug” (design element) 308, a collection of contact information 310 including labels (e.g., telephone, fax number), and information 312 associated with the business or person. From the various elements of the business card 300, tags can be generated, and a file name generated from the tags or portions thereof. For example, a file name for the image shown in FIG. 2 could be “READER_RECIPE Sweet Potato Chicken Curry.tif” Other information (e.g., date, number of pages, one or more ingredients in the recipe) may be included in the name of the file depending on, for example a preconfigured setting or preference(s) set by a user. Broadly, in an exemplary embodiment, the method for generating a file name or file name string comprises the following steps:
I. Definition Stage: is the (input or source) file an electronic document (e.g., DOCX, TXT, etc.) or image (e.g., photo of a document or scanned document—JPG file, TIF file, etc.)?
   1. If the input file is an image, then OCR and/or related functions are performed. Optionally, document classification can be performed. During document classification, at least one document type hypothesis is generated (i.e., a type hypothesis about a type of document that corresponds to the document). For each document type hypothesis, classification includes verifying said document type hypothesis including (a) performing a search for tags which are distinctive for this type of document; and (b) selecting a best or most appropriate document type hypothesis.
II. Tag Extraction Stage
   2. If the input file is an electronic document then text and layout information are extracted from it.
   3. The extracted information and, optionally, a selected best document type hypothesis, are used during tag extraction. A tag list is created.
   4. The best or desired tags from the tag list are selected.
   5. A file name string is generated based on the selected tags or other document features.
   6. Optionally, the document is saved with a newly formed name based on the file name string. Saving the document may include saving the identified or derived tags.

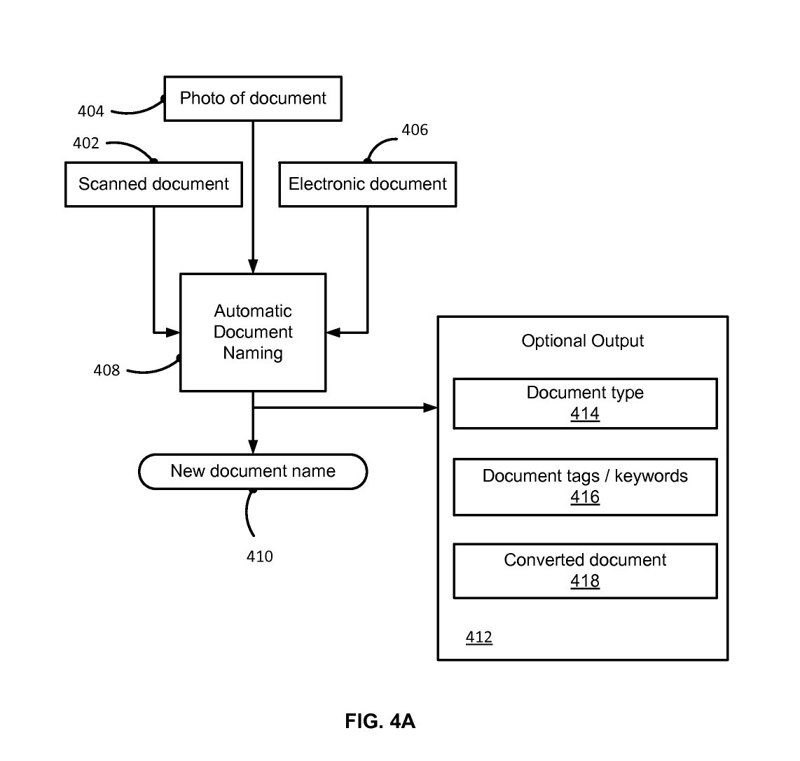

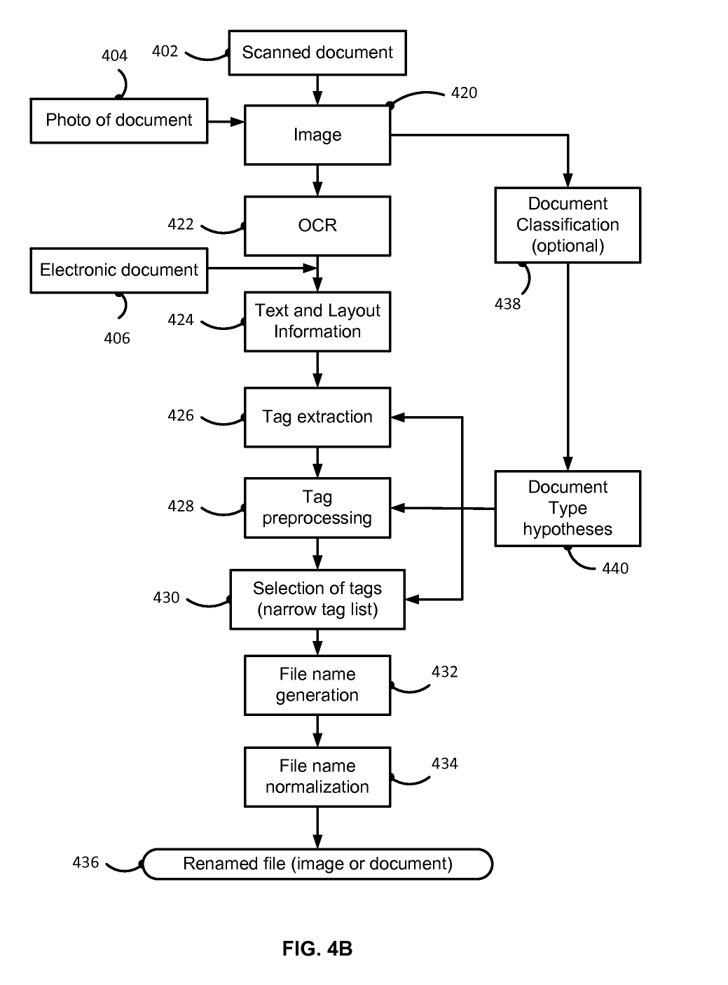

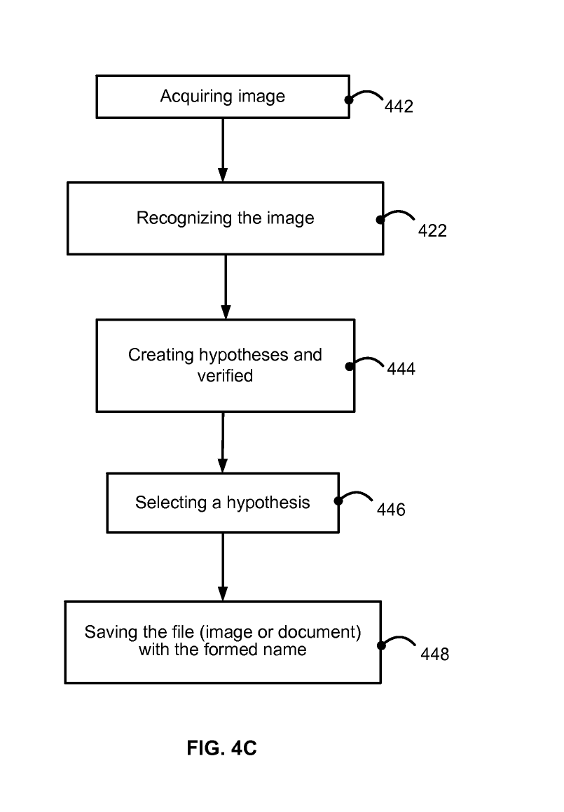

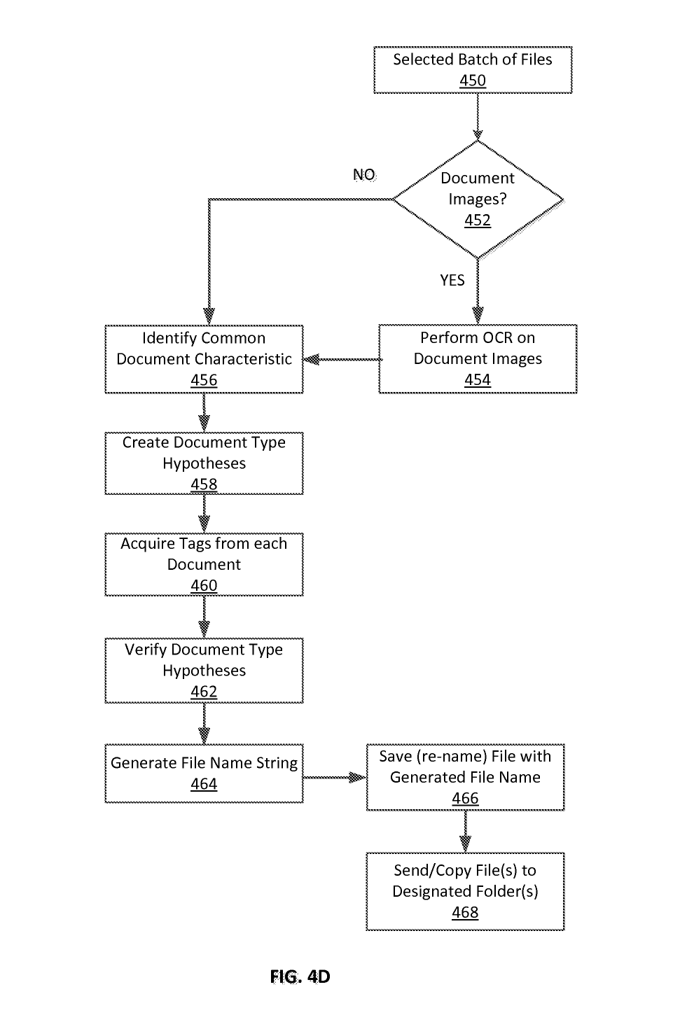

FIG. 4A shows a flowchart in accordance with one implementation of the invention. With reference to FIG. 4A, the method includes taking an image of a document 402, a photo or image of a document 404, or an electronic document 406 and performing an automatic document naming. Such may be done with an automatic document naming component 408 (e.g., programming, logic, computer object code, computer source code, operating system function). A document name 410 is one result of the document naming. Optionally, various data may result from automatic document naming (including tag extraction). The optional output 412 includes one or more document types 414, document tags and/or keywords 416 and a converted document 418.

FIG. 4B shows a flowchart for a detailed algorithm or method in accordance with one embodiment or implementation of the invention. With reference to FIG. 4B, a scan of a document 402 or image that includes a document 404 may be the source of an image 420. An optical character recognition (OCR) and related processing is performed 422 on the image 420. Text and layout information 424 are identified and captured. Alternatively, an electronic document 406 may already include encoded text and may be such electronic document 406 may be processed to acquire text and layout information. Tag extraction 426 is performed to acquire desired information from the text, layout and other information. Tag preprocessing 428 may be performed. In one implementation, tag preprocessing includes normalization of text or file names generated from one or more tags. Normalization includes adjusting text to confirm to an expression that is comfortable for human consumption (e.g., reading, searching). Normalization also includes adjusting text from a variety of tags or derived from a plurality of images to be consistent with one another. For example, a tag that includes “page number 160” can be normalized to “page 160” for the current image and for subsequent (or other) documents. As another example, a url such as “http://www.google.com” can be normalized to “Google”. As another example, an email address, “sergey.marey@abbyy.com” can be normalized to “sergey marey, abbyy”. As another example, a name, “Helen Droval” may be normalized to “H.Droval”. Tag preprocessing can be performed at different times and in different ways. For example, tag extraction can be combined with tag extraction 426, after selection of tags 430 or after file name generation 432.

Selection of tags may include ranking of tags for subsequent file name generation. In a preferred implementation, all extracted tags are ranked. An assigned rank can depend on one or more factors such as a tag type, a document type, presence of other similar tags in the document, presence of other different tags in the document, and a tag's location in the document. One or more tags with a maximal rank are selected. A file name is formed using the selected tags. In one embodiment, an optimal file name is a combination of a group of tags. This group may include two parts. The first part is a “descriptive” and corresponds to a document type description. The second part is a unique or semi-unique part, such as a serial number, or some text that can likely distinguish the file name from hundreds or thousands of other file names. Examples of a two-art file name are “invoice 20_march” or “Business card John Smith, ABBYY”. Several extracted tags (or parts thereof) may be combined when creating a “part” for a two-part file name. In another embodiment, a file name can include only one of the two parts from a two-part file name. For example, a file name may be “20_march” (no ‘descriptive part’) or “invoice” (no unique part). The exact parts used may be automatically determined, or may be based on configurations or preferences available to the name generation algorithms, routines, software, etc.

Returning to FIG. 4B, next, tags are selected 430. The selection of tags 430 may involve selecting a best set of tags, or may involve selecting desired tags (assuming those tags are available for the particular image). At this stage, selection of tags 430 may involve a narrowing of the tag list, and making this list available to a user or to an automated process or program. From the selection of tags, file name generation 432 is performed. For a series or collection of images (documents) or depending on preferences or a configuration setting, file names may be normalized. For example, dates may be put into a standard format (e.g., 2012-09-13). In another example, names may be converted to mixed case (e.g., Marina Selegey where the tag extracted from the document is “MARINA SELEGEY.” After file name normalization 434, the actual electronic file is renamed with the new name 436.

Optionally, the process may involve performing a document classification 438 from the image 420. Document classification 438 is described in further detail herein. Document classification 438 yields one or more document type hypotheses 440. These document type hypotheses, either verified or non-verified, may serve to inform or affect tag extraction 426, tag preprocessing 428, and selection of tags 430. For example, if a tag for a particular image includes the text “recipe” but the document classification returns a high probability (through a document type hypothesis 440) that the image 420 is that of a letter, then during tag selection 430, the method can discard or omit the tag for “recipe” as a candidate for renaming the file (image or document) as a “recipe.”

FIG. 4C shows a flowchart for a method in accordance with another embodiment of the invention. With reference to FIG. 4C, an image is acquired 442. The image is recognized 422 or submitted to one or more processes related to OCR. Then, hypotheses are created 444 (put forward) and are verified. A hypothesis about the image is selected 446. The file is saved with the newly formed name 448; the newly formed name is informed by the hypothesis and recognition.

FIG. 4D shows a flowchart for a method in accordance with another embodiment of the invention. With reference to FIG. 4D, the method includes selecting a batch of files to be saved with a newly generated name 450. Said electronic files may be located on the user's storage device or may be newly acquired from another source such as from a scanner or from a location accessible across one or more protocols associated with the Internet. Next, it is determined if any, some or all of these electronic files include images of documents 452. If so, electronic files in the batch containing document images are identified and subjected to OCR 454; OCR processing creates computer cognizable (encoded) text. Each of the electronic files in the batch is then analyzed for common characteristics between or among them 456. A document type hypothesis is generated for each electronic file 458, if possible. One or more tags are acquired from each electronic file in the batch 460, if possible. Document type hypotheses are verified using, for example, the acquired tags 462. A file name sting is generated 464 for each electronic file based on one or more document type hypotheses, one or more tags, etc. Each electronic file is saved or re-named with its new name 466. In one implementation, each newly created filed name string is compared against the existing file name of each respective electronic file. If it is determined that no significant improvement would result, the respective electronic file is not renamed. Optionally, each electronic file is sent to a designated folder. A designated folder may be a folder or file location (e.g., network location, location in a local storage, location associated with a computer user account, Internet account) based on a file type or other user specified parameter 468. A designated folder may be a newly created folder that is created and named based on a discovered common characteristic of the electronic files in the batch. Alternatively, a designated folder may be a newly created folder that is created and named based on a hypothesis, verified hypothesis or one or more tags associated with one or more of the electronic files in the batch of electronic files.

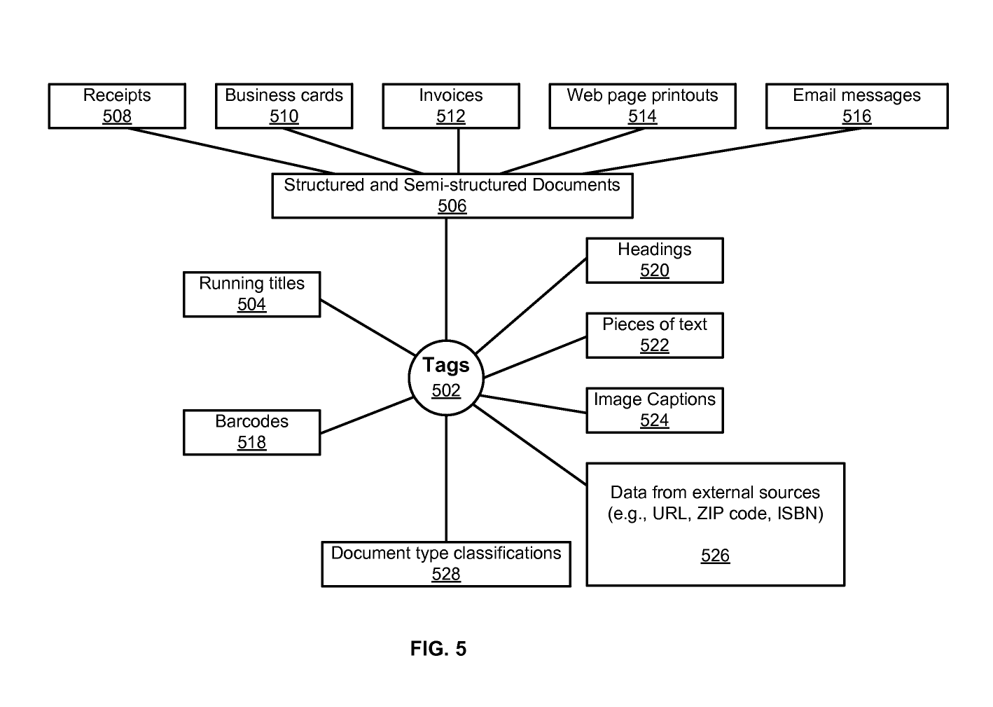

FIG. 5 shows a data structure and set of data derived from a representation of a document or image in accordance with one embodiment of the invention. With reference to FIG. 5, one or more tags 502 may be derived or generated from access to one or more aspects of a document or image. For example, a tag 502 may include information from running titles 504 such as page numbers, author, document title, a URL in a document printout, a data, a title of a document sent by fax, and so on. Data for tags 502 may also come from information derived from structured and semi-structured documents 506. Examples of such documents include: receipts 508, business cards 510, invoices 512, Web page printouts 514, email messages 516. Data for tags 502 may also come from barcodes 518 and information derived from barcodes 518. For example, a QR code may encode or lead to a URL, which in turn may lead to a Web page from which may be captured a title, date of creation, author, etc. Data for tags 502 may also come from headings, subheadings, chapter headings and other features of documents. Data for tags 502 may also come from miscellaneous pieces of text, for example dates, keywords, repeated words, and words associated with standard structural features of a document. Examples of structural features of a document may include the “subject” line of a formal letter; a name associated with a signature line of a letter; a date stamped or found in a footer, header or signature line of a letter. Data for tags 502 may also come from captions 524 or other text associated with an image identified on a particular page of a document. Data for tags 502 may also come from data derived from sources external from the document 526. Examples of such external data include EAN barcodes, ISBN's, ZIP codes and URL's. Each of these examples may lead to other information—examples are, respectively, a product name, a book title, a city name, and a Web page title field. Data for tags 502 may also come from results from document type classification 528. Examples of classifications are: receipt, business card, newspaper, agreement, and magazine. Each of these labels or classes of documents may then be used as a tag or as part of a tag.

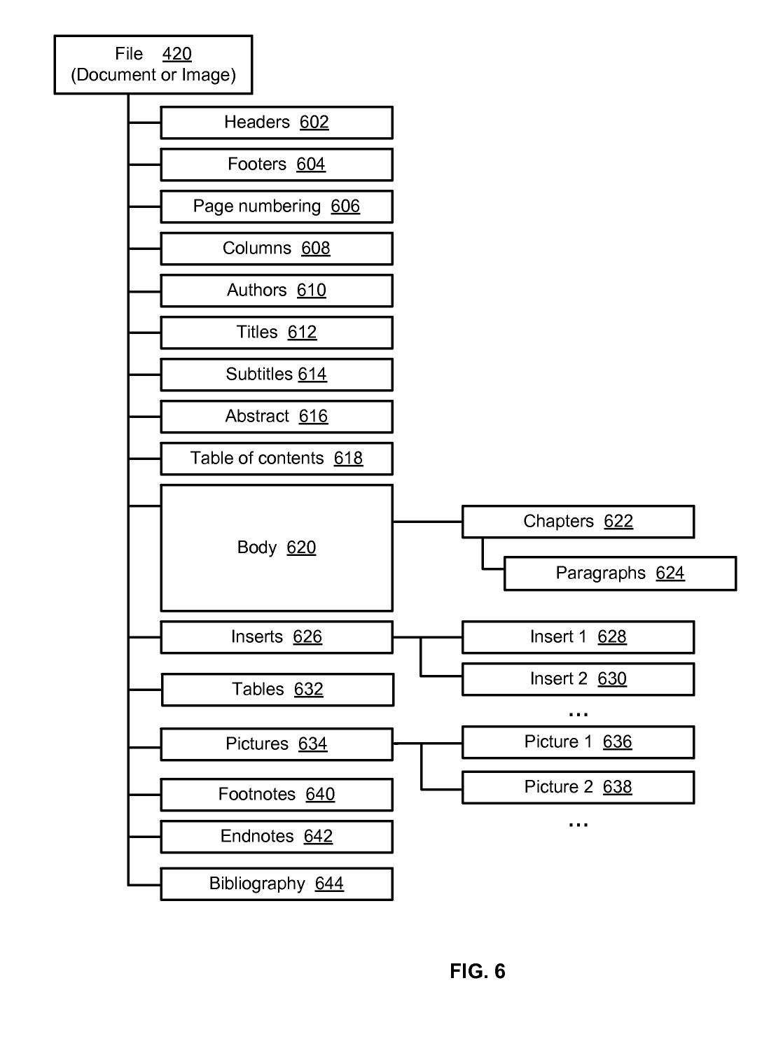

FIG. 6 shows a composite data structure derived from a representation of a generic or universal-like file (document or image) in accordance with another embodiment of the invention. With reference to FIG. 6, an image (or file or document) 420 may be analyzed, such as by OCR and related algorithms, and found to have one or more features (e.g., data structures). The features include, for example, headers 602, footers 604, page numbering 606, columns 608, authors 610, titles 612, subtitles 614, an abstract 616, a table of contents 618, and body 620. The body 620 may include such features as chapters 622 and paragraphs 624 or other types of text units. The features of a file may also include inserts 626 (or overlays) and each insert may have other inserts such as represented in FIG. 6 as Insert 1 (628) and Insert 2 (630). The features of a file may also include tables 632, pictures 634, footnotes 640, endnotes 642 and a bibliography 644. From an evaluation a picture 634, the particular picture may include a “picture within a picture.” Therefore, a picture 634 may include sub pictures represented as Picture 1 (636) and Picture 2 (638). Other features may be found in a file 420.

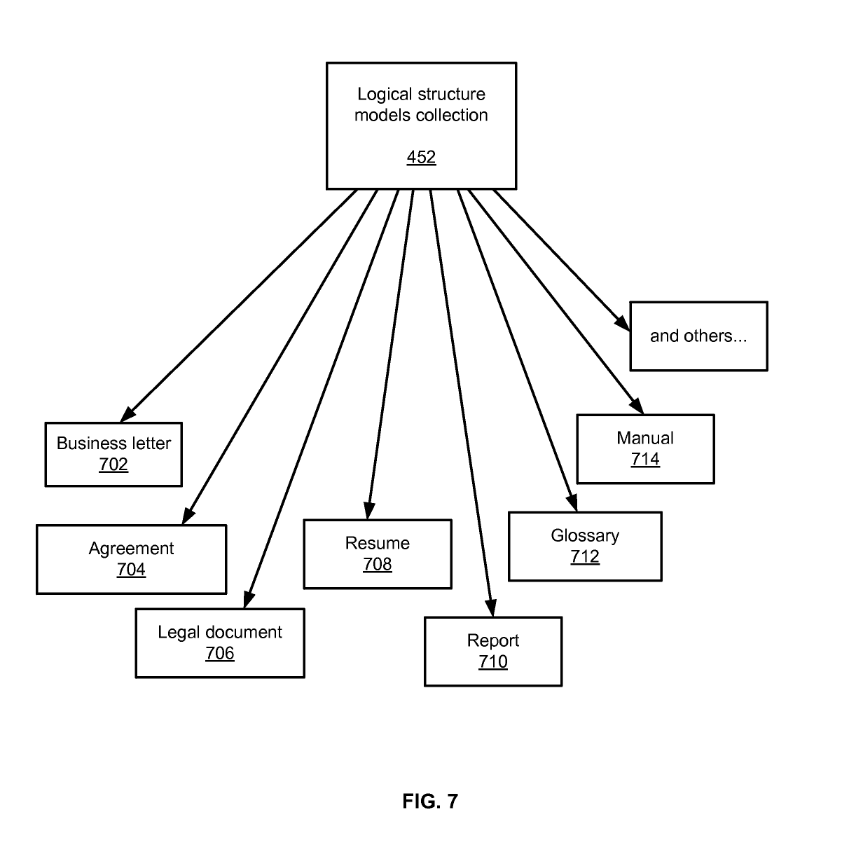

FIG. 7 shows a variety of document types that may be derived from data associated or derived from a representation of a document in accordance with an embodiment of the invention. These document types may be placed into a collection of logical structure models such as that collection shown in FIG. 7 (452). With reference to FIG. 7, a collection of logical structure models 700 may include a business letter 702, an agreement 704, a legal document 706, a resume 708, a report 710, a glossary 712, a manual 714, and others.

In one embodiment, the system comprises an imaging device connected to a computer programmed with specially designed OCR (ICR) software, functionality, algorithms or the like. The system is used to scan a paper-based document (source document) or to make a digital photo of it so as to produce a document image thereof. In another embodiment, such document image may be made with a digital camera (or mobile phone, smart phone, tablet computer and the like), received through a medium such as e-mail, captured from or with a software application, or obtained from an online OCR Web-based service.

Any given document may have several specific fields and form elements. For example, a document may have several titles, subtitles, headers and footers, an address, a registration number, an issue date field, a reception date field, page numbering, etc. Some of the titles may have one of several pre-defined specified values, for example: Invoice, Credit Note, Agreement, Assignment, Declaration, Curriculum Vitae, Business Card, etc. Other documents may include such identifying words as “Dear . . . ”, “Sincerely yours” or “Best regards.” The presence of these words coupled with their characteristic location on a page will often allow the system to classify the document as belonging to a particular type (e.g., personal letter, business letter).

Apart from the unique features typical of the given document type, the document may include unique values corresponding to respective unique features, for example: invoice number, credit note number, a date of the agreement, signatories to the assignment, the name of the person submitting the curriculum vitae, or the name of the holder of the business card person, etc. In one embodiment, the OCR software compares a value with descriptions of possible types available to the software in order to generate a hypothesis about the type of the source document. Then the hypothesis is verified and the recognized text is transformed to reproduce the native formatting of the source document. After processing, recognized text may be exported into an extended editable document format, for example, Microsoft Word format, rich text format (RTF), or Tagged PDF, and may be given a unique name based on the identified document type and its unique features. For example, “Invoice.sub.--#880,” “Credit Note.sub.--888,” “Agreement.sub.--543,” “Agreement.sub.--543_page_{—}1,” “Agreement.sub.--543_page_{—}2,” “Agreement.sub.--12.03.2009,” “Curriculum Vitae Nicole Bishop,” “Business Card of Ingerlei Renata,” “Letter to Mr Juan Valdez,” “Letter from Mr. Willy Wonka,” etc.

In another embodiment, the logical structure of the document is recognized and is used to arrive at conclusions about the style and a possible name for the recognized document. For example, the system may determine whether it is a business letter, a contract, a legal document, a certificate, an application, etc. The system recognizes the document and checks how well each of the generated hypotheses correspond to the actual properties of the document. The system evaluates each hypothesis based on a degree of correspondence between the hypothesis and the information, properties or tags extracted from the document. The hypothesis with the highest correlation with the actual properties of the document is selected.

In order to process a document image, in one embodiment, the system is provisioned with information about specific words which may be found and the possible mutual arrangement of form elements. As noted above, the form elements include elements such as columns (main text), headers and footers, endnotes and footnotes, an abstract (text fragment below the title), headings (together with their hierarchy and numbering), a table of contents, a list of figures, bibliography, the document's title, the numbers and captions of figures and tables, etc.

Some embodiments of the invention include integrating automatic file naming into equipment and processes including scanners, digital cameras, hard drives, flash memory drives, servers, personal computers, cloud services like email, operating systems, and internet search engines.

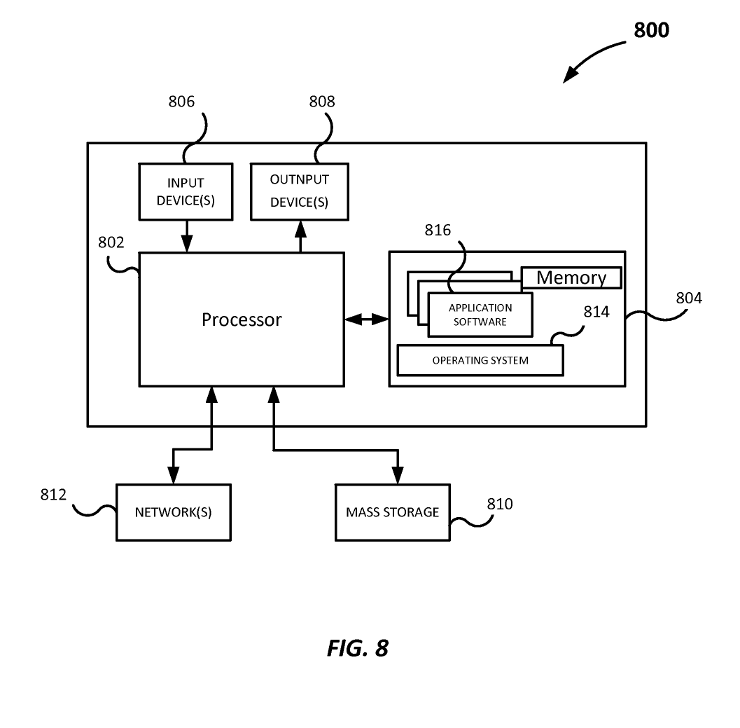

FIG. 8 of the drawings shows an example of hardware 800 that may be used to implement the system, in accordance with one embodiment of the invention. The hardware 800 typically includes at least one processor 802 coupled to a memory 804. The processor 802 may represent one or more processors (e.g., microprocessors), and the memory 804 may represent random access memory (RAM) devices comprising a main storage of the hardware 800, as well as any supplemental levels of memory, e.g., cache memories, non-volatile or back-up-memories (e.g. programmable or flash memories), read-only memories, etc. In addition, the memory 804 may be considered to include memory storage physically located elsewhere in the hardware 800, e.g. any cache memory in the processor 802 as well as any storage capacity used as a virtual memory, e.g., as stored on a mass storage device 810.

The hardware 800 also typically receives a number of inputs and outputs for communicating information externally. For interface with a user or operator, the hardware 800 may include one or more user input devices 806 (e.g., a keyboard, a mouse, imaging device, scanner, etc.) and a one or more output devices 808 (e.g., a Liquid Crystal Display (LCD) panel, a sound playback device (speaker).

For additional storage, the hardware 800 may also include one or more mass storage devices 810, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 800 may include an interface with one or more networks 812 (e.g., a local area network (LAN), a wide area network (WAN), a wireless network, and/or the Internet among others) to permit the communication of information with other computers coupled to the networks. It should be appreciated that the hardware 800 typically includes suitable analog and/or digital interfaces between the processor 802 and each of the components 804, 806, 808, and 812 as is well known in the art.

The hardware 800 operates under the control of an operating system 814, and executes various computer software applications, components, programs, objects, modules, etc. to implement the techniques described above. Moreover, various applications, components, programs, objects, etc., collectively indicated by reference 816 in FIG. 8, may also execute on one or more processors in another computer coupled to the hardware 800 via a network 812, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks, (DVDs), etc.).

In the previous description, for purposes of explanation, numerous specific details are set forth in order to provide an understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

We claim:

1. A method for naming electronic files, the method comprising:
detecting a user selection on an electronic display a group of two or more electronic files from a list of electronic files;
determining a common characteristic of the electronic files in the group;
creating at least one document type hypothesis for each electronic file in the group;
determining tags for each electronic file from components of the respective electronic file;
verifying each of the document type hypotheses for the electronic files in the group using the selected tags;
calculating and assigning a rating value to each document type hypothesis for each electronic file in the group;
determining a document type hypothesis for each electronic file in the group based on said rating values of the document type hypotheses;
forming a file name string for each electronic file in the group based on: (1) the identified common characteristic of the group, (2) said selected tags for the respective electronic file, or (3) said selected document type hypothesis for the respective electronic file; and
naming and saving in a computer readable medium a file name based on said formed file name string for each of the electronic files in the group.

2. The method of claim 1, wherein the method further comprises:
prior to creating the at least one document type hypothesis for each electronic file in the group, performing optical character recognition (OCR) on the respective electronic file, wherein the OCR process includes generating encoded text using the electronic file.

3. The method of claim 2, wherein the method further comprises:
saving in the computer readable medium the generated encoded text from each file in a new electronic file.

4. The method of claim 2, wherein the method further comprises:
after performing OCR on the electronic files, creating tags based on the generated encoded text, wherein said forming the file name string is based on the created tags and determined tags.

5. The method of claim 1, wherein creating the at least one document type hypothesis for each electronic file in the group includes basing at least one of the document type hypotheses on non-tag features of the respective electronic file.

6. The method of claim 1, wherein creating the at least one document type hypothesis for each electronic file in the group includes basing at least one of the document type hypotheses on non-tag content of the respective electronic file.

7. The method of claim 1, wherein forming the file name string for the respective electronic file in the group comprises forming the respective file name string based on information derived from attributes of the respective electronic file.

8. The method of claim 1, wherein forming the file name string for the respective electronic file in the group comprises forming the respective file name string based on information derived from a layout of the respective electronic file.

9. The method of claim 1, wherein forming the file name string for the respective electronic file includes forming a semi-unique file name string from a semi-unique value associated with or assigned to the electronic file.

10. The method of claim 1, wherein the formed file name string for each respective electronic file is based on a normalized sequence of characters based on a document type corresponding to the selected document type hypothesis.

11. The method of claim 1, wherein the method further comprises:
prior to forming the file name string for each electronic file in the group, determining a logical structure of the electronic file, wherein forming the file name string for the respective electronic file is based on the logical structure of the electronic file.

12. The method of claim 1, wherein the method further comprises determining, for each respective electronic file, a model from a plurality of pre-defined models, and wherein the file name string for the respective electronic file is based on said selected model.

13. The method of claim 1, wherein the method further comprises sending each of the electronic files to a designated folder for the group of electronic files based on one or more common characteristics of the electronic files in the group.

14. An electronic device for facilitating naming of each of a group of electronic files, the device comprising:
a processor;
a storage device in electronic communication with the processor;
a memory in electronic communication with the processor and storage device; and
computer instructions stored in the storage device that allow the electronic device to:
receive a selection of a group of electronic files;
determine a common characteristic of the electronic files in the group;
determine tags related to each electronic file using the respective electronic file;
form a file name string for each electronic file in the group based on identified tags or one or more identified common characteristics of the group; and
save in the storage device or memory a file name based on said formed file name string for each of the electronic files in the group.

15. The electronic device of claim 14 further comprising:
create a first document type hypothesis for each electronic file based on the selected tags;
attempt to verify the first document type hypothesis for each respective electronic file;
create a second respective document type hypothesis if the first respective document type hypothesis is not verified; and
modify the file name string for the respective electronic file based on said first respective document type hypothesis or said second respective document type hypothesis.

16. The electronic device of claim 15, wherein the electronic device further comprises an electronic display, and wherein the tags are displayed on the electronic display.

17. The electronic device of claim 15, wherein creating the second respective document type hypothesis uses non-tag features of the respective electronic file.

18. One or more non-transient computer-readable media encoded with instructions for performing steps, the steps including:
detecting a user selection on an electronic display a group of two or more electronic files from a list of electronic files;
determining a common characteristic of the electronic files in the group;
creating at least one document type hypothesis for each electronic file in the group;
determining tags for each electronic file from components of the respective electronic file;
verifying each of the document type hypotheses for the electronic files in the group using the selected tags;
calculating and assigning a rating value to each document type hypothesis for each electronic file in the group;
determining a document type hypothesis for each electronic file in the group based on said rating values of the document type hypotheses;
forming a file name string for each electronic file in the group based on: (1) the identified common characteristic of the group, (2) said selected tags for the respective electronic file, or (3) said selected document type hypothesis for the respective electronic file; and
naming and saving in a computer readable medium a file name based on said formed file name string for each of the electronic files in the group.

19. The one or more non-transient computer-readable media of claim 18, wherein the steps further include:
performing optical character recognition (OCR) on the respective electronic file, wherein the OCR process includes generating encoded text from the electronic file.

20. The one or more non-transient computer-readable media of claim 19, wherein the steps further include:
creating tags based on the generated encoded text, and wherein said forming the file name string is based on the created tags.

21. The one or more non-transient computer-readable media of claim 18, wherein creating the at least one document type hypothesis for each electronic file in the group includes using non-tag features of the respective electronic file.

22. The one or more non-transient computer-readable media of claim 18, wherein creating the at least one document type hypothesis for each electronic file in the group includes using contents of the respective electronic file.

23. The one or more non-transient computer-readable media of claim 18, wherein creating the at least one document type hypothesis for each electronic file in the group includes using attributes of the respective electronic file.

24. The one or more non-transient computer-readable media of claim 18, wherein the formed file name string for each respective electronic file is based on a normalized sequence of characters based on a document type corresponding to the determined document type hypothesis.
